(19) United States
(12) Patent Application Publication
(10) Pub. No.: US 2026/0172698 A1
(43) Pub. Date: Jun. 18, 2026

(54) METHOD FOR PROCESSING DIGITAL IMAGE LINE DATA FROM A TDI LINE SCAN CAMERA

(71) Applicant: ISRA VISION GmbH, Darmstadt (DE)

(72) Inventors: Christian PROBST, München (DE); Björn KUHLBRODT, München (DE); Monssef ALSWEIS, München (DE); Manuel MÜLLER, Hettenshausen (DE)

(21) Appl. No.: 19/416,679

(22) Filed: Dec. 11, 2025

(30) Foreign Application Priority Data
Dec. 13, 2024 (DE) 10 2024 137 686.4

(51) Int. Cl. H04N 23/81; G06T 7/246; H04N 23/73; H04N 23/74

(52) U.S. Cl. CPC H04N 23/81; G06T 7/248; H04N 23/73; H04N 23/74; G06T 2207/10016

(57) ABSTRACT

A computer-implemented method for processing digital image line data generated by a line scan camera, in particular a TDI line scan camera, by exposing an object that is moving at least temporarily relative to the line scan camera. The data generated in this way includes a large number of one-dimensional image lines with a time sequence.

### CROSS-REFERENCE TO PRIOR APPLICATIONS

This application claims priority to German Patent Application No. DE 10 2024 137 686.4 filed Dec. 13, 2024, which is incorporated herein in its entirety.

### TECHNICAL FIELD

The present invention relates to a computer-implemented method for processing digital image line data generated by a line scan camera, in particular a TDI line scan camera, by exposing an object which is moving at least temporarily relative to the line scan camera. The data generated in this way comprises a plurality of one-dimensional image lines provided with a time sequence.

The present invention further relates to a data processing system for executing the computer-implemented method, and to processed image line data obtainable by the computer-implemented method.

Furthermore, the present invention relates to a method for analysing an object moving relative to a line scan camera, in particular a TDI line scan camera.

The present invention further relates to a device and a system for analysing an object moving relative to a line scan camera, in particular a TDI line scan camera.

### BACKGROUND

Line scan cameras are frequently used in the quality monitoring of a manufacturing or machining process of a wide variety of materials which, for example, are moved on a conveyor belt through a production line. Properties of the objects, such as the surface quality, are recorded line by line and converted into image lines. However, conventional line scan cameras can only reliably monitor the quality of an object at limited speeds. If the objects move very quickly, the resolution or light sensitivity of line scan cameras is often insufficient.

If the objects are moved at a very fast speed relative to the camera, as is often the case in industrial environments, or if the lighting conditions are poor, so-called time delay and integration line scan cameras, or TDI line scan cameras for short, offer a better signal-to-noise ratio. In contrast to conventional line scan cameras, TDI line scan cameras have several pixel lines so that several image lines are captured simultaneously. By synchronising the movement of the object with the movement of the image on the sensor of the TDI camera, individual object points are integrated for longer, enabling more accurate images of the object despite high speeds or low light conditions.

However, a TDI camera in particular is in continuous exposure mode to ensure that the image is captured without interruption. Continuous synchronisation for the generation of the image lines is essential in order to forward and sum up the data correctly.

However, the synchronisation of the camera with the movement of the object and the uninterrupted exposure state have the disadvantage that changes in speed or a standstill of the object lead to a change in image noise and brightness. Monitoring with a TDI line scan camera is therefore difficult or even impossible, especially for quality monitoring of products that are moved in batches. Such products can be solar panels, for example.

### SUMMARY

The present invention is therefore based on the problem of providing a computer-implemented method for processing digital image line scan data, a corresponding data processing system and a method for analysing a moving object with a line scan camera or correspondingly processed image line scan data, in which a change in speed of an object transported at high speed has less or no influence on quality monitoring.

The present invention is further based on the problem of providing a device and a system which enable the aforementioned methods.

This problem is solved by a computer-implemented method for processing digital image line data which has been generated by a line scan camera, in particular a TDI line scan camera, by exposing an object which is moving at least temporarily relative to the line scan camera, so that the image line data comprises a plurality of one-dimensional image lines provided with a temporal sequence, with the following steps:
A) determining whether a relative speed of the object with respect to the line scan camera has fallen below a predefined lower speed limit during exposure by the line scan camera;
B) processing the image line data depending on whether the speed of an image line has fallen below the predefined lower speed limit in step A);
C) providing the image line data processed by means of step B).

When processing the generated image line data, the computer-implemented method according to the invention thus distinguishes between pixel data that was captured during a correspondingly fast movement of the object and pixel data that was captured while the object was travelling slowly or while it was stationary. If it is determined in step A) of the method according to the invention that the speed falls below a certain lower speed limit, the image line data is processed differently than in standard operation of the line scan camera.

In one embodiment, the determination of a possible undershooting of the predefined lower speed limit in step A) is carried out as a function of additionally recorded speed values and/or position values of the object and/or as a function of additionally recorded speed values and/or position values of the line scan camera.

In particular, the additionally recorded speed values and/or position values are preferably recorded using a signalling device, in particular a rotary encoder.

In a further embodiment, the determination in step A) is carried out continuously at a monitoring frequency, wherein in step B) a signal processor is operated in a first configuration, in which the signal processor triggers illumination flashes and image line feeds at a first readout frequency if it is determined in step A) that the speed has not fallen below the lower speed limit, and wherein in step B) a signal processor is operated in a second configuration in which the signal processor does not trigger an illumination flash and triggers image line feeds at a second readout frequency if it is determined in step A) that the speed has fallen below the lower speed limit, wherein the second readout frequency is greater, preferably ten times greater, than the first readout frequency. For the purposes of the present invention, an image line feed is to be understood as the start of the readout of a new one-dimensional pixel line.

In a further embodiment, the determination of a possible undershooting of the predefined speed in step A) is carried out as a function of the digital image line data, preferably exclusively as a function of the digital image line data. Additional sensors for detecting the speed of the object are therefore not required, so that the quality monitoring system can be simplified.

In a further embodiment, the image data is processed in step B) within the line scan camera, preferably within a buffer memory of the line scan camera, so that the image line data processed in step B) can be output as output data of the line scan camera. This means that the camera only outputs image line data that has been cleaned up accordingly and no longer contains artefacts caused by the object moving slowly or stopping. Processing directly in the line scan camera offers the advantage that all the necessary data is available immediately and transmission times are eliminated. This offers the possibility of real-time processing.

Alternatively, the image line data is processed in step B) outside the line scan camera, preferably in the immediate vicinity of an imaging process used to generate the image line data, on an additional physical data carrier. It is conceivable, for example, that the image line data could be processed in a cloud.

In a further embodiment, the processing in step B) comprises at least the following sub-steps:
B1) filtering out image lines for which the relative speed of the object is less than the predefined lower speed limit;
B2) merging the image lines remaining after the filtering in step B1) to obtain the processed image line data.

In other words, image lines captured during a speed below the lower speed limit are discarded so that the processed image line data only contains image lines captured during a speed above the lower speed limit. In this way, the use of a line scan camera, in particular a TDI line scan camera, is also possible for objects that are moved in batches and whose stop would have led to overexposure during the previously known operation of the TDI line scan camera.

In a further embodiment, the processing in step B) comprises at least the following sub-steps:
B-i) determining an image line within the temporal sequence at which the relative speed of the object with respect to the line scan camera has fallen below a predefined lower speed limit;
B-ii) filtering out the image line determined in step B-i and at least one image line which immediately precedes or follows the image line determined in step B-i in the time sequence, wherein preferably several image lines, in particular a number of image lines selected from the closed interval between 4 and the total number of TDI levels of the line scan camera, are filtered out, wherein this number of image lines immediately precedes or follows the image line determined in step B-i in the temporal sequence.

Image lines that were captured in the border area of a slow movement or a stop are therefore either also discarded or calculated with a correction function and then used to create the sequence of image line data, i.e. to create the two-dimensional image. This ensures that the image line data is sufficiently corrected and that all artefacts due to the change in speed are eliminated as completely as possible. This generates image line data with uniform brightness.

For the image lines filtered out in step B-ii, the lower speed limit does not necessarily have to be undershot for these image lines.

For the purposes of the present invention, filtering out image lines is to be understood as further processing of image lines, in particular processing in the sense of discarding or correction with subsequent use for creating the two-dimensional image of the object.

In the context of the present invention, TDI levels of a line scan camera are to be understood as a number of pixel line sensors of the line scan camera, so that such a line scan camera is consequently a TDI line scan camera. The total number of TDI levels therefore corresponds to the total number of pixel line sensors of the TDI line scan camera used.

In a further embodiment, in step A) it is determined whether a relative speed of the object with respect to the line scan camera has fallen below a predefined lower speed limit during an exposure by the line scan camera, in part or completely by the fact that the property, preferably the brightness, of at least one reference pixel of the image lines and/or the time variation of the property, preferably of the brightness, of the at least one reference pixel of the image lines is determined, wherein it is determined as a function of the property thus determined, in particular brightness, and/or the temporal property curve thus determined, in particular temporal brightness curve, whether the lower speed limit for an image line is undershot or not, wherein the spatial reference pixel position is the same and predefined for all image lines of the image line data.

This makes it possible to identify whether or not the speed limit has been undershot based solely on the captured image line data.

In a further embodiment, it is determined in step A whether a relative speed of the object with respect to the line scan camera has fallen below a predefined lower speed limit during an exposure by the TDI camera, partly or completely by determining a ratio of useful signal to interference signal for each image line, in particular for a reference pixel of each image line, and determining whether the relative speed has fallen below the lower speed limit for the image line under consideration as a function of the ratio thus determined.

The problem underlying the invention is also solved by a data processing system comprising a calculation device, in particular a physical processor, virtual processor or computer, wherein the calculation device is designed and/or configured in such a way that the calculation device executes a computer-implemented method according to one of the preceding embodiments of a computer-implemented method according to the invention.

The problem underlying the invention is also solved by a computer-readable storage medium with a computer program stored thereon which, when executed on a computer system, executes a method according to one of the preceding embodiments of a computer-implemented method according to the invention.

The problem underlying the invention is also solved by processed image line data obtainable by a method according to one of the preceding embodiments of a computer-implemented method according to the invention.

The problem underlying the invention is also solved by a method for analysing an object moving relative to a line scan camera, in particular a TDI line scan camera, comprising the steps of:
AA) providing the object to be analysed and the line scan camera so that the object to be analysed moves at least temporarily relative to the line scan camera;
BB) aligning and operating the line scan camera so that the line scan camera captures image lines of the object to be analysed line by line in a time sequence;
CC) processing the image lines captured in step BB and having the temporal sequence, which together form image line data, by means of a computer-implemented method according to one of the preceding embodiments of a computer-implemented method according to the invention.

In one embodiment, the aforementioned method comprises the following further step:
DD) arranging a reference element in the field of view of the line scan camera in step BB), such that each image line captured by the line scan camera additionally captures the reference element in addition to the object to be analysed, wherein the reference element is arranged stationary relative to the line scan camera;
   wherein in step DD) preferably a computer-implemented method is carried out, in which in step A the determination of whether a relative speed of the object with respect to the line scan camera has fallen below a predefined lower speed limit during an exposure by the line scan camera is carried out partially or completely by determining the property, preferably the brightness, of at least one reference pixel of the image lines and/or the time variation of the property, preferably the brightness, of the at least one reference pixel of the image lines, wherein, as a function of the property determined in this way, in particular brightness, and/or the temporal property curve determined in this way, in particular temporal brightness curve, it is determined whether or not the lower speed limit for an image line is undershot, wherein the spatial reference pixel position is the same and predefined for all image lines of the image line data, and the reference element is arranged in such a way that the reference pixel of each image line detects the reference element at least in certain areas.

In a further embodiment, in step AA) the object is a material web moving on a linear conveyor belt at a varying speed, in particular in batches, for example a solar cell panel provided as a material web, wherein the line scan camera is aligned in such a way that it captures image lines aligned perpendicular to the feed direction of the material web.

In particular, the line scan camera can also be operated and synchronised with a feed device, such as a conveyor belt on which the object is transported at least temporarily, in such a way that the object is illuminated with a light source, in particular a flash light source, when the object moves relative to the line scan camera, and the object is not illuminated with the light source when the object does not move relative to the line scan camera. Furthermore, a reference plate can then be provided in the field of view of the line scan camera in particular, which is aligned and arranged in such a way that it is fixed in relation to the line scan camera regardless of the movement of the object and thus never moves relative to the line scan camera during operation of the feed device. The line scan camera then always captures at least one pixel whose image content reproduces the reference disc and can be used as a reference pixel-as described above, for example. This is because, regardless of the object to be captured and its structure, such a reference pixel always has a predefined brightness due to the coupling of the illuminant and the feed device, depending on whether the object is moving relative to the line scan camera or whether the object is stationary relative to the line scan camera. Based on the brightness of the reference pixel, image line data can then either be assigned to an image data memory, in which a 2-dimensional image of the object is generated by the sequence of image line data, or pushed into an additional readout memory or discarded directly.

The problem underlying the invention is also solved by a device for analysing an object which moves at least temporarily relative to a line scan camera, wherein the device comprises the line scan camera, which may in particular be a TDI line scan camera, wherein the line scan camera can be arranged and aligned relative to a conveying means in such a way that an object moved by the conveying means enters a field of view of the line scan camera, wherein the device comprises a reference element, in particular a reference plate, wherein the reference element is designed and arranged in such a way that the reference element is arranged in a fixed position in the field of view of the line scan camera. In particular, the reference element is arranged in a fixed position in the field of view of the line scan camera in such a way that the reference element does not move relative to the line scan camera during operation of the means of transport. This device makes it possible to determine whether the relative speed of the object in relation to the line scan camera has fallen below a predefined lower speed limit during exposure by the line scan camera, without the need for any sensors other than the line scan camera itself.

According to one embodiment of the device, the device comprises the conveying means, in particular a linear conveyor belt, wherein the transport means is designed such that the object can be moved relative to the line scan camera.

The reference element can in particular be a reference plate. In particular, the reference element can be firmly connected to the line scan camera via a mounting device. In particular, the reference element can consist of a metal and/or plastic material. In particular, the reference element may have a light colour, e.g. be designed in white.

According to one embodiment of the device, the reference element is designed and arranged such that the reference element fills at least one pixel of the line scan camera in an image captured by the line scan camera, preferably a number of pixels from the closed interval [1, 5], particularly preferably a number of pixels from the closed interval [1, 3].

The problem underlying the invention is also solved by a system, in particular a system for carrying out a method described above for analysing an object moving relative to a line scan camera, in particular a TDI line scan camera, wherein the system comprises a device according to one of the embodiments described above, wherein the system is designed and configured such that, as a function of a property of a pixel with which the reference element is detected, it is determined whether an object moving through the conveying means has fallen below a predefined lower speed limit relative to the line scan camera during exposure by the line scan camera. The property of the pixel is, in particular, the brightness of the pixel.

### BRIEF DESCRIPTION OF THE FIGURES

Further advantages, features and possible applications of the present invention will become clear from the following description of various embodiments.

It Shows Schematically:
FIG. 1: an embodiment of a data processing system according to the invention with a line scan camera;
FIG. 2: the principle of a TDI line scan camera;
FIG. 3: excerpts from an embodiment of a method according to the invention for operating a TDI line scan camera;
FIG. 4: a further embodiment of a data processing system according to the invention with a line scan camera.

### DETAILED DESCRIPTION OF PARTICULAR EMBODIMENTS

The advantages of the present invention become particularly clear if the basic principle of a line scan camera 1, in particular a continuously exposed line scan camera 1 such as a TDI line scan camera, is first considered.

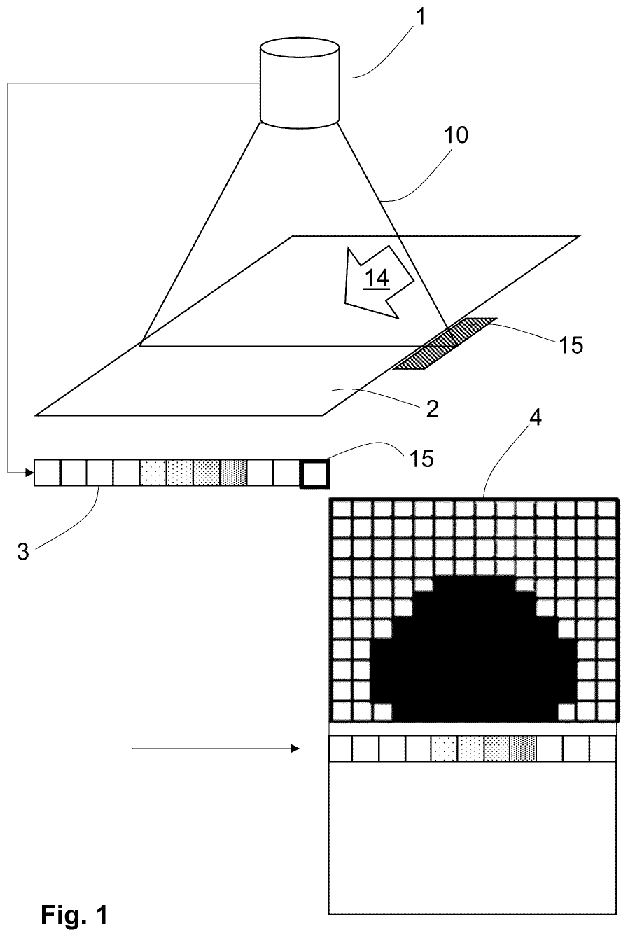

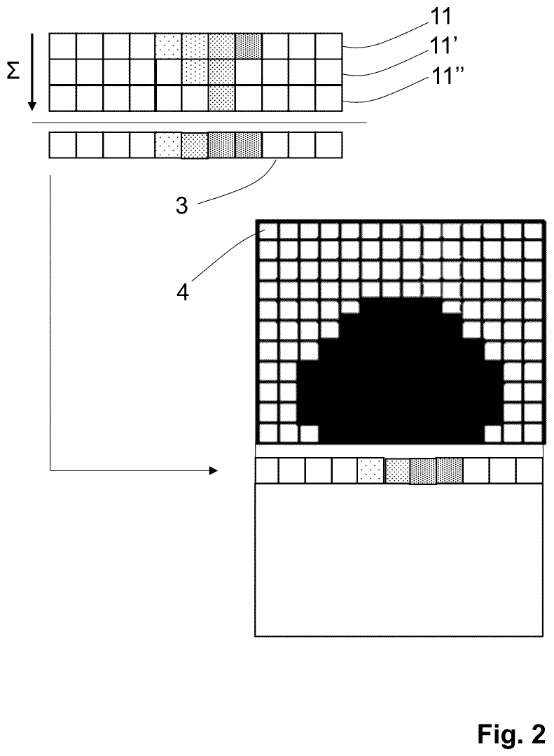

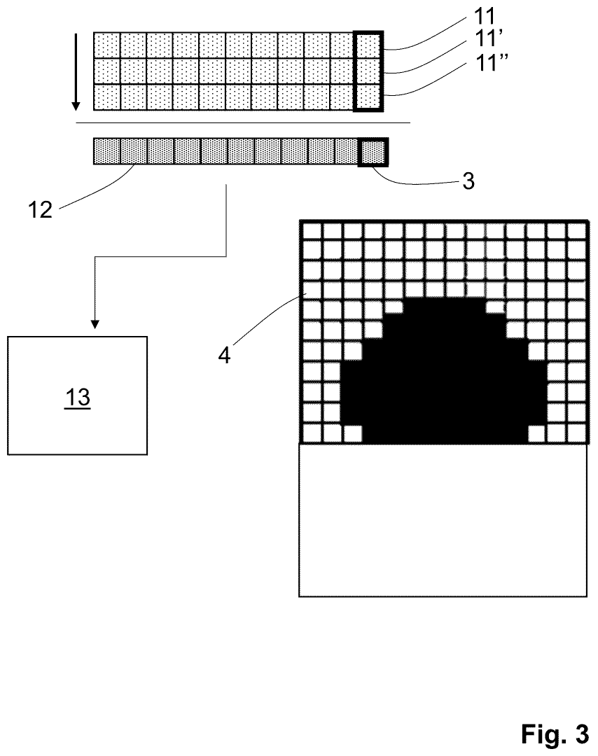

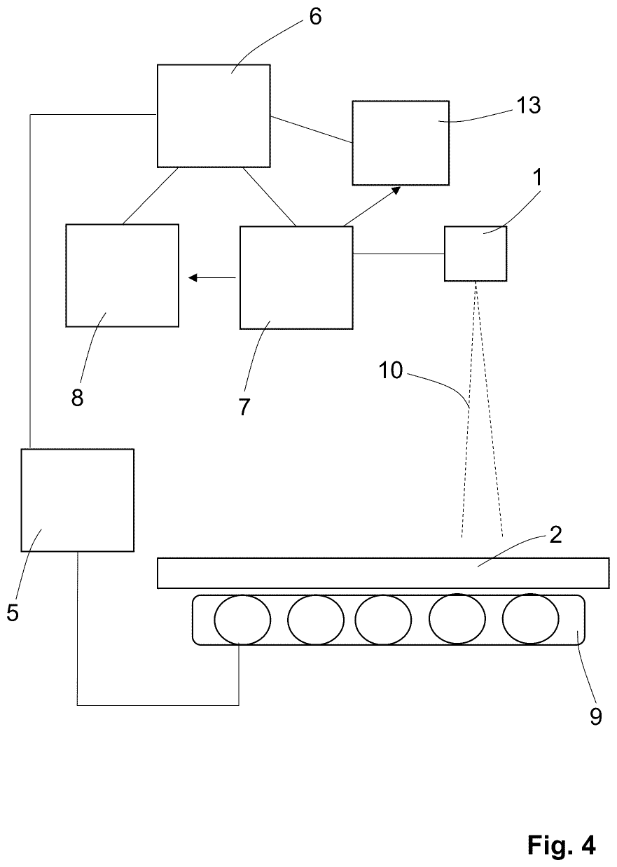

FIG. 1, which shows extracts from a data processing system according to the invention, shows, among other things, a line scan camera 1 whose field of view 10 is directed towards a web-shaped object 2. The object 2 moves along a feed direction 14 by means of a feed device 9 not shown in detail here in FIG. 1 (such a device is shown in FIG. 4), for example by means of a conveyor belt provided for this purpose. The line scan camera 1 is aligned in such a way that the image lines captured as image line data 3 extend essentially perpendicular to the feed direction 14. In principle, however, other arrangements with an angle of less than 90 degrees between the image lines and the feed direction 14 are also possible.

The image line data 3 each contain a one-dimensional pixel line. At the same time, the line scan camera 1 is synchronised with the feed device 9 in such a way that image line data 3, which contains a single image line in the form of a one-dimensional pixel line, is continuously read out and added to a sequence 4 of image line data 3, so that ultimately a two-dimensional image of the moving object 2 results from the sequence 4 of image line data read out.

If the line scan camera 1 only has a single pixel line sensor with which a pixel line can be captured, the method is limited to certain areas of application. In particular, the feed speed of the object 2 must not be too high-as already mentioned at the beginning so that the exposure times are sufficiently long to produce a qualitatively usable image. Against this background, FIG. 2 shows, among other things, the principle of a TDI line scan camera 1, in which several (here: three) image lines arranged next to each other along the feed direction are captured by correspondingly several (here: three) pixel line sensors arranged next to each other along the feed direction. The captured signals are then summed pixel by pixel-along the feed direction-so that a single image line is determined by the TDI camera and made available for further processing. By using several line sensors positioned next to each other in the feed direction, a significantly higher light yield can be achieved so that even fast-moving objects 2 can be inspected with a sufficiently good quality using a TDI line scan camera 1. For this type of process, it is necessary for the line sensors to work in continuous exposure mode. In other words, the photocells of the TDI line scan camera 1 detect photons continuously.

As long as the object 2 moves continuously and the pixel memories are read out regularly, a TDI line scan camera 1 delivers very good results in practice. However, if the object 2 is only moved intermittently, for example, so that the object 2 stands still in between, the continuous exposure causes the line sensors to continuously capture photons and the pixel data memories behind each pixel to fill up to saturation. The corresponding image lines then no longer correctly depict the object 2 to be captured. For example, it can happen that contrasts that are actually present are no longer visible due to the saturation of the sensors. FIG. 3 shows a corresponding state in which all pixel data memories of the pixel line converge.

With the method according to the invention also shown in FIG. 3, these pixel data memories are now read out at high frequency and the image line data 3 read out in the process is not added to the sequence 4 of image line data, but is shifted to a readout memory or deleted immediately. This takes place as step B of the method according to the invention. This step B takes place depending on whether it has been determined in step A that the object 2 has fallen below a lower relative speed limit. If the relative speed subsequently elevates again after falling below and exceeds the lower speed limit, the system switches back to the previously described mode, the standard mode, depending on the point in time at which it was exceeded, so that further image line data 3 is added to the 2-dimensional image of the object.

In other words, the object is scanned in a stop-and-go mode. If the object is not moving, the image data memory 8 is not written any further (stop). If the object moves, the image data memory 8 is written to (go).

In the embodiment shown in FIG. 3, a reference pixel 12 can be used, for example, to determine in step A whether a speed limit has been undershot. As shown in FIG. 1, the TDI line scan camera 1 is aligned and the system is designed in such a way that the reference pixel 12 detects a reference disc 15 that is permanently installed opposite the TDI line scan camera. The relative speed of line scan camera 1 and reference plate 15 is therefore always zero. The system and the reference plate 15 are designed in such a way that the number of photon signals collected in the reference pixel data memory or, in other words, the detected brightness correlates with the relative speed of the object to be detected according to a predefined behaviour. If a certain limit for the number of photons is exceeded, a control unit 6 of the system (here: a signal processor) knows that the relative speed has fallen below a certain lower limit. The use of such a reference pixel 12 enables the image line data 3 to be processed according to the invention independently of other additional data. In other words, processing can be carried out solely on the basis of image line data 3. Several reference pixels 12 can also be provided within a summed image line.

In addition, the reference disc 15 or the signal of the reference pixel 12 can be used to determine any acceleration of the object 2 to be captured relative to the line scan camera 1. Depending on the acceleration, image line data 3 captured at relative speeds that lie between the lower speed limit and a predefined standard speed can be calculated using a correction function in order to subsequently add them to the sequence of image line data 4. In other words, this image line data 3, which was not captured at standard speeds but above the lower speed limit, is evaluated with a predefined weighting-using a predefined correction function-and used to capture the two-dimensional image.

It can also or alternatively be determined whether a lower speed limit has been undershot or exceeded again by means of an additional signal, which is detected at the feed device 9 during operation of the TDI line scan camera 1. A suitable system for this is shown schematically in FIG. 4. Here, the web-shaped object 2 to be detected is transported on a conveyor belt along a feed direction 14. At the same time, the TDI line scan camera 1—as in FIG. 1—continuously captures image line data 3, the image lines of which extend essentially perpendicular to the feed direction 14. A signalling device 5, which can be designed as a rotary encoder, detects a state of the feed device 9, in particular the rotational angle position of a shaft of the conveyor belt or directly the speed of the conveyor belt. This allows the relative speed of the object 2 in relation to the line scan camera 1 to be determined. The signalling device 5 is connected to a control unit 6, for example a processor, wherein the control unit 6 initiates the following depending on whether the relative speed of the object 2 is above or below the lower speed limit: namely that the image line data 3 is read out at a first readout frequency, which is synchronised with the relative speed of the object and the TDI line scan camera, and is added to a sequence 4 of image line data by writing it to an image data memory 8 provided for this purpose, in order to obtain a two-dimensional image of the object 2 with this sequence 4 if the relative speed is above the lower speed limit; or that the image line data are read out at a second readout frequency, which is greater than the first readout frequency, and discarded, for example by moving them to a separate readout data memory 7 provided for this purpose if the speed is below the lower speed limit.

### REFERENCE SYMBOL LIST

1 Line scan camera/camera sensor
2 Web-shaped object
3 Image line data
4 Sequence of image line data
5 Signalling device, in particular rotary encoder
6 Control unit/signal processor
7 Readout data memory
8 Image data memory
9 Feed device/conveyor belt
10 Field of view
11 Integration pixel line
11′Integration pixel line
11″ Integration pixel line
12 Reference pixel
13 Readout memory
14 Feed direction
15 Reference plate

1. A computer-implemented method for processing digital image line data generated by a line scan camera, by exposing an object which is moving at least temporarily relative to the line scan camera, so that the image line data comprises a plurality of one-dimensional image lines provided with a time sequence, comprising the steps of:
A) determining whether a relative speed of the object with respect to the line scan camera has fallen below a predefined lower speed limit during exposure by the line scan camera;
B) processing the image line data depending on whether the speed of an image line has fallen below the predefined lower speed limit in step A; and
C) providing the image line data processed in step B.

2. The computer-implemented method according to claim 1, wherein the determination of a possible undershooting of the predefined lower speed limit in step A is carried out as a function of additionally detected speed values and/or position values of the object and/or as a function of additionally detected speed values and/or position values of the line scan camera.

3. The computer-implemented method according to claim 2, wherein the additionally recorded speed values and/or position values are detected with a signalling device.

4. The computer-implemented method according to claim 3,
wherein the determination in step A is performed continuously at a monitoring frequency,
wherein in step B a signal processor is operated in a first configuration in which the signal processor triggers illumination flashes and image line feeds at a first readout frequency when it is determined in step A that the speed has not fallen below the lower speed limit,
and wherein, in step B, a signal processor is operated in a second configuration in which the signal processor does not trigger illumination flashes and triggers image line feeds at a second readout frequency if it is determined in step A that the speed has fallen below the lower speed limit,
wherein the second readout frequency is greater, than the first readout frequency.

5. The computer-implemented method according to claim 1,
wherein the determination of a possible undershooting of the predefined speed in step A is performed as a function of the digital image line data,

6. The computer-implemented method according to claim 1,
wherein the processing of the image data in step B takes place within the line scan camera, so that the image line data processed in step B can be output as output data of the line scan camera.

7. The computer-implemented method according to claim 1,
wherein the processing in step B comprises at least the following substeps:
B1) filtering out image lines for which the relative speed of the object is less than the predefined speed lower limit;
B2) merging the image lines remaining after the filtering in step B1 to obtain the processed image line data.

8. The computer-implemented method according to claim 1,
wherein the processing in step B comprises at least the following substeps:
B-i) determining an image line within the temporal sequence at which the relative speed of the object with respect to the line scan camera has fallen below a predefined lower speed limit;
B-ii) filtering out the image line determined in step B-i and at least one image line which immediately precedes or follows the image line determined in step B-i in the time sequence,

9. The computer-implemented method according to claim 1,
wherein, in step A, the determination of whether a relative speed of the object with respect to the line scan camera has fallen below a predefined lower speed limit during an exposure by the line scan camera is performed partially or completely by determining the property, of at least one reference pixel of the image lines and/or the time variation of the property, of the at least one reference pixel of the image lines,
wherein it is determined as a function of the property thus determined, and/or the temporal property curve thus determined, whether the lower speed limit for an image line is undershot or not, wherein the spatial reference pixel position is the same and predefined for all image lines of the image line data.

10. The computer-implemented method according to claim 1, wherein in step A the determination of whether a relative speed of the object with respect to the line scan camera has fallen below a predefined lower speed limit during an exposure by the line scan camera is carried out partially or completely wherein for each image line, a ratio of useful signal to interference signal is determined and, as a function of the ratio thus determined, it is determined whether the relative speed has fallen below the lower speed limit for the image line under consideration.

11. A data processing system comprising a calculation device, wherein the calculation device is designed and/or configured in such a way that the calculation device executes a computer-implemented method according to claim 1.

12. Processed image line data obtainable by the method according to claim 1 .

13. A method for analysing an object moving relative to a line scan camera, comprising the steps of:
AA) providing the object to be analysed and the line scan camera so that the object to be analysed moves at least temporarily relative to the line scan camera;
BB) aligning and operating the line scan camera so that the line scan camera captures image lines of the object to be analysed line by line in a time sequence;
CC) processing the image lines captured in step BB and having the temporal sequence, which together form image line data, by the computer-implemented method according to claim 1.

14. The method according to claim 13,
wherein the method comprises the following further step:
DD) arranging a reference element in the field of view of the line scan camera in step BB), such that each image line captured by the line scan camera additionally captures the reference element in addition to the object to be analysed, wherein the reference element is arranged stationary relative to the line scan camera.

15. The method according to claim 13—
wherein in step AA) the object is a material web, moving on a linear conveyor belt at a varying speed,
wherein the line scan camera is aligned such that it captures image lines aligned perpendicular to the feed direction of the material web.

16. A device for analysing an object moving at least temporarily relative to a line scan camera, wherein the device comprises:
a line scan camera, wherein the line scan camera can be arranged and aligned relative to a conveying means in such a way that an object moved by the conveying means enters a field of view of the line scan camera,
a reference element, wherein the reference element is designed and arranged such that the reference element is in a fixed position in the field of view of the line scan camera.

17. The device according to claim 16,
wherein the reference element is designed and arranged such that the reference element fills at least one pixel of the line scan camera in an image captured by the line scan camera,

18. A system
the device according to claim 16,
wherein the system is designed and configured such that, as a function of a property of a pixel with which the reference element is detected, it is determined whether an object moved by the conveying means has fallen below a predefined lower speed limit relative to the line scan camera during exposure by the line scan camera.

19. The computer-implemented method according to claim 8, wherein several image lines are filtered out, wherein this number of image lines immediately precedes or follows the image line determined in step B-I in the temporal sequence.

20. A method for analysing an object moving relative to a line scan camera comprising the steps of:
AA) providing the object to be analysed and the line scan camera so that the object to be analysed moves at least temporarily relative to the line scan camera;
BB) aligning and operating the line scan camera so that the line scan camera captures image lines of the object to be analysed line by line in a time sequence;
CC) processing the image lines captured in step BB and having the temporal sequence, which together form image line data, by the computer-implemented method according to claim 9;
DD) arranging a reference element in the field of view of the line scan camera in step BB), such that each image line captured by the line scan camera additionally captures the reference element in addition to the object to be analysed, wherein the reference element is arranged stationary relative to the line scan camera;
wherein in step DD) the reference element is arranged such that the reference pixel of each image line detects the reference element at least in certain areas.
